(19) United States
(12) Patent Application Publication
(10) Pub. No.: US 2012/0137340 A1
(43) Pub. Date: May 31, 2012

(54) IMPLICIT AUTHENTICATION

(75) Inventors: Bjorn Markus Jakobsson, Mountain View, CA (US); Richard Chow, Sunnyvale, CA (US); Runting Shi, San Jose, CA (US)

(73) Assignee: Palo Alto Research Center Incorporated, Palo Alto, CA (US)

(21) Appl. No.: 12/955,825

(22) Filed: Nov. 29, 2010

(51) Int. Cl. G06F 21/00

(52) U.S. Cl. 726/1; 726/21

(57) ABSTRACT

Embodiments of the present disclosure provide a method and system for implicitly authenticating a user to access controlled resources. The system first receives a request to access the controlled resource from a user. Then, the system determines whether the user request is inconsistent with regular user behavior by calculating a user behavior measure derived from historical contextual data of past user events. Next, responsive to the determined inconsistency of the user request, the system collects current contextual data of the user from one or more user devices without prompting the user to perform an explicit action for authentication. The system further updates the user behavior measure based on the collected current contextual data, and provides the updated user behavior measure to an access controller of the controlled resource to make an authentication decision based at least on the updated user behavior measure.

### RELATED APPLICATION

The subject matter of this application is related to the subject matter in a co-pending non-provisional application by Bjorn Markus Jakobsson, Mark J. Grandcolas, Philippe J. P. Golle, Richard Chow, and Runting Shi entitled “IMPLICIT AUTHENTICATION,” having Ser. No. 12/504,159 and filing date 16 Jul. 2009 (Attorney Docket No. PARC-20090232-US-NP), the disclosure of which is incorporated by reference herein.

### BACKGROUND

1. Field

This disclosure is generally related to user authentication. More specifically, this disclosure is related to a method and system for implicitly authenticating a user to access a controlled resource based on contextual data indicating the user's behavior.

2. Related Art

A mobile internet device (MID) is a multimedia-capable handheld computer providing wireless Internet access. MIDs are designed to provide entertainment, information and location-based services for personal use. As the market for MIDs expands, mobile commerce (also known as M-commerce) is experiencing rapid growth. There is a trend toward hosting applications and services on the Internet. This results in increased demand for Internet authentication—whether of devices, computers or users. Moreover, the use of digital rights management (DRM) policies will likely increase the need for frequent authentications. Some of such authentications may happen simultaneously due to the increased use of mashups.

On the other hand, the shift toward greater market penetration of MIDs complicates password entry due to the limitations of MID input interfaces. Typing passwords on mobile devices, such as an iPhone™ or a B1ackBerry™, can become a tedious and error-prone process.

Single sign-on (SSO) is an authentication mechanism to control the access of multiple, related, but independent software applications and services. With SSO, a user logs in once and gains access to all applications and services without being prompted to log in again for each of them. SSO addresses the problem of frequent authentications. However, SSO does not defend against theft and compromise of devices because it only vouches for the identity of the device, not its user.

### SUMMARY

One embodiment provides a system that implicitly authenticates a user to access a controlled resource. The system first receives a request to access the controlled resource from a user. Then, the system determines whether the user request is inconsistent with regular user behavior by calculating a user behavior measure derived from historical contextual data of past user events. Next, responsive to the determined inconsistency of the user request, the system collects current contextual data of the user from one or more user devices without prompting the user to perform an explicit action for authentication. The system further updates the user behavior measure based on the collected current contextual data, and provides the updated user behavior measure to an access controller of the controlled resource to make an authentication decision based at least on the updated user behavior measure.

In some embodiments, the system also determines a quality measure which is a scale indicating the likelihood of an event associated with the user happening in a given context. The system then determines a weight indicating the relative importance of a given event. Next, the system adjusts the user behavior measure based on the quality measure and the weight.

In some embodiments, the current contextual data of the user comprises one or more of: location data, time data, calendar information, social network information, communication information, and online data.

In some embodiments, the system applies a set of heuristic rules to adjust the user behavior measure based on the collected current contextual data.

In some embodiments, the system also derives updating rules for the user behavior measure from the collected current contextual data.

In another embodiment, the system also generates a set of rules using machine-learning technique from the collected current contextual data.

In some embodiments, the system also determines whether the updated user behavior measure meets a predetermined threshold value. If so, the system authenticates the user to access the controlled resource.

In another embodiment, the system prompts the user to perform a further authentication, responsive to the updated user behavior measure not meeting the threshold value.

### BRIEF DESCRIPTION OF THE FIGURES

FIG. 1 presents a schematic illustrating a system for implicitly authenticating a user to access a controlled network resource in accordance with an embodiment of the present invention.

FIG. 2 presents a block diagram illustrating a computing environment for implicitly authenticating a user to access a controlled resource in accordance with an embodiment of the present invention.

FIG. 3 presents a flow chart illustrating a method for implicitly authenticating a user to access a controlled resource in accordance with an embodiment of the present invention.

FIG. 4 presents a flow chart illustrating the process of adjusting a user behavior measure based on the current contextual data in accordance with an embodiment of the present invention.

FIG. 5 presents a block diagram illustrating an apparatus for implicitly authenticating a user to access a controlled resource in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a method for implicitly authenticating a user to access a controlled resource without the need for entering passwords or answering any authentication questions based on contextual data indicating the user's behavior. In one embodiment, the contextual data comprises the environment that a user is in, and the activities that the user is engaged in. If the environment and the activities exhibit familiar patterns (for example, the user is detected to be in her office, or the user has just made a ten-minute phone call to her significant other), it is deemed safe to authenticate the user without prompting for a password or security question. On the other hand, if the detected environment and activities associated with the user exhibit anomalies or deviations from the user's normal behavior, it is deemed unsafe to grant access to the user, as the device may have been lost or stolen.

In one embodiment, the system calculates a user behavior measure based on a user behavior model derived from historical contextual data of the user collected from one or more user devices. If the user behavior measure is higher than a predetermined threshold, the system authenticates the user to access the controlled resource. If the user behavior measure is lower than the predetermined threshold, the system requires the user to be authenticated explicitly, for example, by requesting the user to provide a user credential to access the controlled resource.

In some embodiments, by calculating the user behavior measure, the system determines that the user request to access a controlled resource is inconsistent with regular user behavior. The system then collects current contextual data of the user from one or more user devices without prompting the user to perform an explicit action for authentication. Next, the system applies a set of heuristic rules to adjust the user behavior measure based on the newly collected current contextual data. For example, the user is detected to be not in her office, but in a nearby parking lot. Some heuristic rules may be defined to safely authenticate the user without prompting for a password or security question if the user is within a certain range of her office. On the other hand, if the detected location is thousands of miles away, it may be unsafe to grant access to the user without further authentication.

### Computing Environment

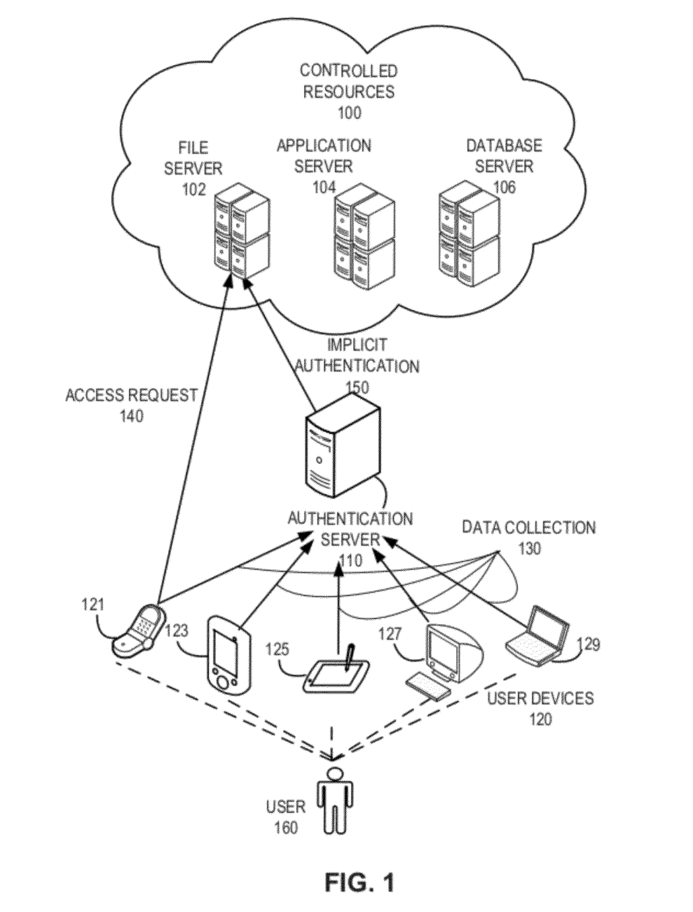

FIG. 1 shows a schematic of a computing environment for implicitly authenticating a user to access a controlled network resource in accordance with an embodiment of the present invention. In this example, the computing environment includes controlled resources 100, an authentication server 110, a plurality of user devices 120 and a user 160. Controlled resources 100 can include any resource on a network, and a mechanism for providing access to such resources upon receiving requests from a user. For example, controlled resources 100 may include, but are not limited to, a file server 102, an application server 104, a database server 106, a mail server (not shown), etc. Authentication server 110 can be any type of computational device capable of performing an authorization or authentication operation of a user or a transaction. User devices 120 can generally include any node on a network including computational capability, a mechanism for communicating across the network, and a human interaction interface. This includes, but is not limited to, a smart phone device 121, a personal digital assistant (PDA) 123, a tablet PC 125, a workstation 127, a laptop 129, etc. Note that, although the present invention optimally is used with mobile Internet devices, it can be used with any type of computational device.

During operation, a user 160 sends a request 140 to access a network resource 100. Authentication server 110 collects contextual data about the user 160 from user devices 120 (operation 130), and presents implicit authentication information 150 to the access controller of controlled resources 100 to facilitate authentication of the user 160. In one embodiment, authentication server 110 collects contextual data about the user 160 after controlled resources 100 receives the access request 140 from user devices 120. Authentication server 110 can collect contextual data from user devices 120 and periodically update a user behavior model about user 160.

### Implicit Authentication

The following types of contextual data may be used to serve as indicators of a user's behavior: location; movements; actions; biometrics; other environmental data; co-location, including co-location with a wireless SSID, a mobile device, or a PC or laptop; recent authentication outcomes and scores; and application usage, such as web search queries or web browsing history; etc. Contextual data collected from one or more user devices may include multiple data streams, the combination of which provides a basis for the determination of the user behavior measure. Note that the term “data stream” refers to a stream of data of any type described herein.

This contextual data can be grouped into three classes based on the data sources used to make authentication decisions: device data, which are data primarily available on the device; carrier data, which are data available to the carrier; and third-party provider data, which are data available to other application and/or service providers. Note that a specific data type may belong to more than one class.

Many mobile devices are equipped with a Global Positioning System (GPS), and have wireless support, such as Wi-Fi and Bluetooth™. GPS data can be used to determine location and co-location. Also, multi-purpose devices have information about users' application usage, social membership information and user demographic data. In addition, there is contextual data, such as calendar entries, and web browser data containing sites visited. Another important piece of data relates to the success of local authentication attempts and local connection attempts, e.g., password entry and synchronization with already registered devices such as laptops and cars.

Carrier data includes location data which approximates location of the device as identified by a selected cell phone tower. The location data can also give a crude estimation of a co-location. Contextual data is also available from an increasing number of applications hosted on the network by third-party providers. For example, third-party providers may have information about the time and duration of the application use, and application content data, such as calendar entries. Note that carriers are well-suited to be the trusted third party in charge of making authentication inferences and communicating trust statements to qualified providers, because of both their already established trust relationship with the consumer and their natural ability to communicate with the consumer devices.

Contextual data can be represented in various ways. Some contextual data is taken in snapshot form; other contextual data is a continuous trace from the recent past. In some embodiments, data may be represented as a result of a Fourier transform. Data can also be rounded or approximated in different ways. For example, location data could correspond to representations meaning “at home,” “at mall,” “at work,” etc. Data of several categories can be combined to create new data classes.

In a mobile phone example, different types of contextual data includes: phone number, call type, duration of the phone call, location of the phone call, movement of the phone, and identity confidence. The phone number refers to the number associated with calls to or from the mobile phone. Phone numbers may be unregistered or registered, e.g., “wife,” “mother,” “daughter,” “son,” “coworker,” etc. The call type refers to the type of phone calls involved, e.g., incoming, outgoing, missed, forwarded, conferencing, etc. The duration of the call can be classified into different categories: less than 5 minutes, between 5 and 10 minutes, between 10 and 30 minutes, between 30 and 60 minutes, and over 60 minutes. The location refers to the location of the mobile phone as indicated, for example, by the GPS data. Locations may be either unregistered or registered, e.g., “home,” “school,” “work,” “grocery store,” etc. The movement describes the speed at which the mobile device is detected to move, such as undetected, static, slow, medium, and fast. Finally, the identity confidence indicates the level of confidence that the user is the person using the mobile device. In some embodiments, identity confidence may be classified into categories, such as >95%, 90-95%, 80-90%, 70-80%, . . . <10%, etc.

A user behavior model describes a user's behavior pattern by associating different data types together. In the above mobile phone example, e.g., a user behavior model can be conceptually built to indicate that there is a greater than 95% chance that the device is being used by its intended user when the user receives a phone call at home from his wife and talks for over an hour. As another example, a second user behavior model may indicate that it is quite likely that the device is with its intended user when the user calls his wife's phone number for five minutes from a known grocery store. By contrast, another user behavior model indicates that there is a less than 10% chance that the user is the owner of the mobile device when the user calls an unknown number in a fast-moving vehicle for over an hour.

The above-described user behavior models are merely one embodiment of many possible conceptual models. It is not intended to be exhaustive or to limit the present invention to the forms disclosed. The user behavior models described herein are for easy conceptual understanding. The actual design and storage of the user behavior models may vary in different systems.

In embodiments of the present invention, determination of implicit authentication for a user to access a controlled resource depends on a user's behavior measure. The user behavior measure takes into account the user behavior model, the request and recent contextual user behavioral. When an event associated with a user device is observed, a rule is usually triggered to adjust the user behavior measure either upwards or downwards. For example, the system may determine a user behavior measure based on the user's calling records. An observed event could be an incoming call, an outgoing call, or initiation of a mobile application from the mobile phone, etc. In one embodiment, a rule includes a history string and an associated event.

The user behavior measure is adjusted based on whether the observed event is consistent with the user's ownership of the device. If so, the user's behavior measure is increased. On the other hand, if the observed user event is inconsistent with the user's ownership of the device, the user behavior measure is decreased. In one embodiment, if the user behavior measure is below a predetermined threshold value, an explicit authentication will be requested by the application or service the user is trying to access. The choice of which authentication method to use may depend on the user behavior measure. For example, the user may be asked to enter a password and to present a security token if the user behavior measure is too low. Alternatively, the user may be asked to enter a password if the user behavior measure is below the threshold value but not low enough to warrant presentation of the security token.

The user behavior measure can be adjusted periodically. In the mobile phone example illustrated above, positive data means that the calling records show that the user is likely to make or receive a phone call at the time of calling for the duration of the call to/from the other person. Negative data means that the calling records show that the user is unlikely to make/receive the phone call at the time of calling for the duration of the call to/from the other person. As a result, to maintain a high user behavior measure, a user needs to build upon positive data continuously over a period of time.

### Improved Implicit Authentication

Embodiments of the present invention facilitate improved implicit authentication to increase the flexibility of the system, thereby lowering chances of unnecessary explicit authentication requests. In one embodiment, even if the system determines that the user request to access a controlled resource is inconsistent with the regular user behavior pattern, the system tries to collect and analyze additional contextual data of the user from one or more user devices without immediately prompting the user to perform an explicit action for authentication. The system further applies a set of heuristic rules to adjust the user behavior measure based on the newly collected current contextual data. These improvements attempt to determine the aptness of an observed behavior based on additional user contextual data, therefore increasing the confidence of the implicit authentication decisions made by the system. The new techniques also integrate the understanding of what constitutes reasonable fluctuations of the user behavior versus what is truly anomalous.

Take the location data as an example: if a user device is spotted outside a regular geographic area, it matters how far—just two miles or a thousand miles away from the regular location. It also matters whether the user's arrival at the new location is consistent with how the user usually moves around, e.g., arriving at a strange location from a thousand miles away in half an hour is impossible. Co-location information can be valuable: a new location may not be abnormal if the user is co-located with a friend with whom the user has often traveled in the past. Moreover, location information of other users in the social network of the observed user helps too: a strange location is not aberrant if it is the home address of an apparent colleague, but suspicious if it is in a national park in Mexico. Therefore, the type of location, the distance between locations, the location information associated with the user's social network, and the co-location information all play important roles in evaluating the user's behavior measure.

In some embodiments, the user behavior measure is associated with the user's contact information, such as phone numbers or email addresses with which the user has communicated in the past. To improve the flexibility of the implicit authentication system, more contextual information needs to be considered. For instance, distance between two users within a social network and number of paths, along with other social measurements of closeness can be examined to identify whether a new phone number is a reliable number that belongs, for example, to a friend of a friend. One can also classify social links as been either professional or social in order to determine the likelihood of multi-hop relations, which affect the user behavior measure associated with exchanging a call/SMS/email with the other party. Different users may exhibit different communication patterns: some users commonly reach out to people at a greater social networking distance (e.g., three hops or more) than other users.

Another example of contextual information is time, such as time of day and day of the week. On a weekday, a user's behavior is more predictable (e.g., going to work), than during the weekend. Hence, behavior fluctuations during the weekend should be penalized less when calculating the behavior measure than fluctuations occurring on a weekday. It is also relevant to consider the past history of the user activities. A user who likes shopping has a greater chance of appearing at a shopping mall she has never visited before than a user who does not go to shopping malls frequently. Similarly, a user who often spends time in state parks on weekends is more likely to be located in a new state park than another user who usually stays at home.

Therefore, it is very meaningful to combine and cross-check different types of contextual information. For example, if a user's schedule indicates a business trip to Mexico which is confirmed by a receipt for purchase of that flight in the user's email, then the user's change of location to Mexico and future phone calls to/from Mexico become quite consistent. This is in contrast to the previous techniques that measure user behavior based only on past activities without any extrapolation. The improved implicit authentication system collects different types of contextual data from one or more user devices, and applies a set of heuristic rules to adjust the user behavior measure based on the newly collected additional contextual data. The heuristic rules for measuring user behavior can be defined by the system administrator. A machine-learning-based measuring mechanism can also be deployed to automatically generate rules for adjusting the user behavior measure.

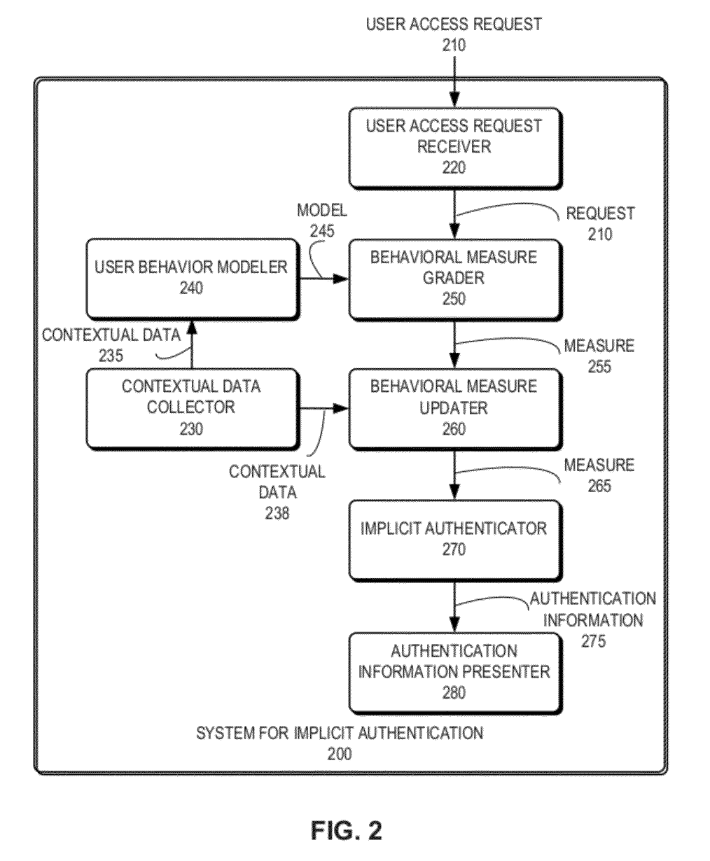

FIG. 2 shows a block diagram of a system 200 for implicitly authenticating a user to access a controlled resource in accordance with an embodiment. System 200 includes a user access request receiver 220, a behavioral measure grader 250, a behavioral measure updater 260, an implicit authenticator 270, and an authentication information presenter 280. System 200 additionally includes a contextual data collector 230 and a user behavior modeler 240.

User access request receiver 220 receives user access request 210 from a user 160, and can be a network port, a wireless receiver, a radio receiver, a media receiver, etc., without any limitation. User access request 210 may be received from user 160, from a resource controller, or from another module that is capable of passing the request. User access request receiver 220 receives and analyzes the user access request 210 and forwards request 210 to the behavioral measure grader 250. In some embodiments, user 160 may not be issuing any request, and the user's device may be a passive responder. Also, the device may be non-operative and/or non-reachable at the time of the request, but may have recently communicated its state.

Behavioral measure grader 250 calculates a behavioral measure of user 160, and can be any computing device with a processing logic and a communication mechanism. Behavioral measure grader 250 receives forwarded user access request 210, contextual data 235 from contextual data collector 230, and a user behavior model 245 from user behavior modeler 240. Behavioral measure grader 250 then calculates a user behavior measure 255 based on request 210, contextual data 235, and user behavior model 245. User behavior measure 255 indicates the likelihood that user 160 who sends user access request 210 from a user device is the owner of the user device. User behavior measure 255 can be adjusted upwards or downwards by behavioral measure updater 260 based on additional contextual data 238 from contextual data collector 230. Updated user behavior measure 265 is then sent to implicit authenticator 270 to facilitate implicit authentication of the user.

Contextual data collector 230 collects contextual data about user 160, and can be any device with a storage and a communication mechanism.

Contextual data 235 and contextual data 238 indicate a user's behavior or environment. Examples of contextual data 235 and 238 include locations, movements, actions, biometrics, authentication outcomes, application usage, web browser data (e.g., recently visited sites), etc. Contextual data 235 and 238 can be collected from a device, a carrier, and/or a third-party provider.

The user behavior modeler 240 creates a user behavior model 245 based on the contextual data 235 about user 160. User behavior model 245 describes a user's historical behavior patterns. User behavior model 245 can include a history string which corresponds to a sequence of observed events, a probability distribution which corresponds to the likelihood of the observed events happening as a function of time, and a measure distribution which corresponds to the change in user behavior measure 255 and 265 resulting from the observed events as a function of time. User behavior modeler 240 can be any type of computing device or component with a computational mechanism.

Implicit authenticator 270 calculates implicit authentication information 275 based on user behavioral measure 265. Implicit authentication information 275 is information that facilitates the access controller of controlled resources to make an authentication decision. Implicit authentication information 275 can be a binary decision or a confidence level based on user behavior measure 265. Authentication information presenter 280 presents implicit authentication information 275 to the access controller of controlled resources.

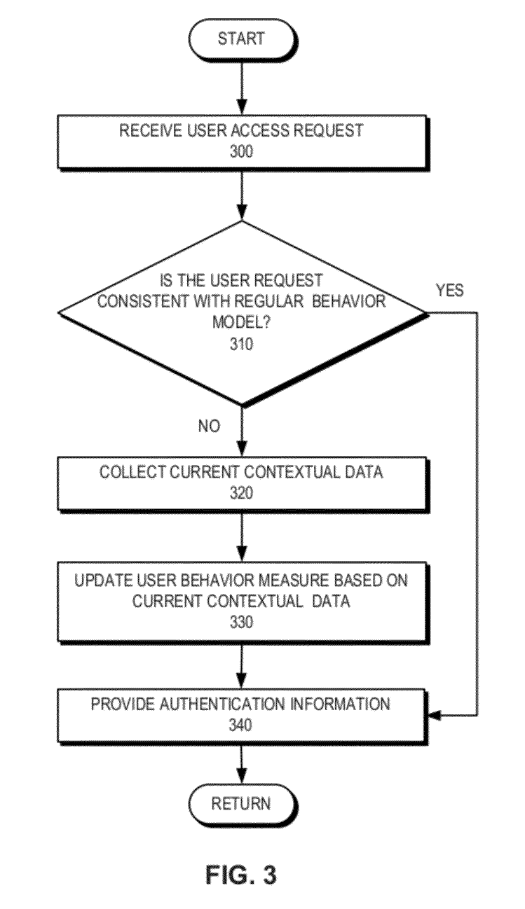

FIG. 3 shows a flow chart illustrating a method for implicitly authenticating a user to access a controlled resource in accordance with an embodiment. During operation, the system receives a user access request (operation 300). The user access request can contain login credentials for resource authentication. In other embodiments, the user access request can merely identify the resource to be accessed without providing any login credentials or authentication information.

The system then determines whether the user access request is consistent with a user behavior model (operation 310) associated with the user who sends the access request. If so, the system provides authentication information (operation 340). Otherwise, the system collects additional current contextual data (operation 320) associated with the user. Based on the request, the user behavior model, and the current contextual data (which describes current user behavior), the system updates the user behavioral measure (operation 330). Finally, the system provides authentication information (operation 340). The implicit authentication information can be a binary authentication decision, or a confidence level.

Although in the example above the system collects additional contextual data and updates user behavior measure after the user request is determined to be inconsistent with the regular behavior model, the system can also collect the contextual data without such determination. In other words, the system can calculate the user behavior measure while incorporating the additional contextual data. Determining that the user request is inconsistent with the regular behavior model does not need to be a predicate for collecting additional contextual data. In addition, the additional contextual data can be used to update the user behavior model, whether the user request is consistent with the user behavior model or not.

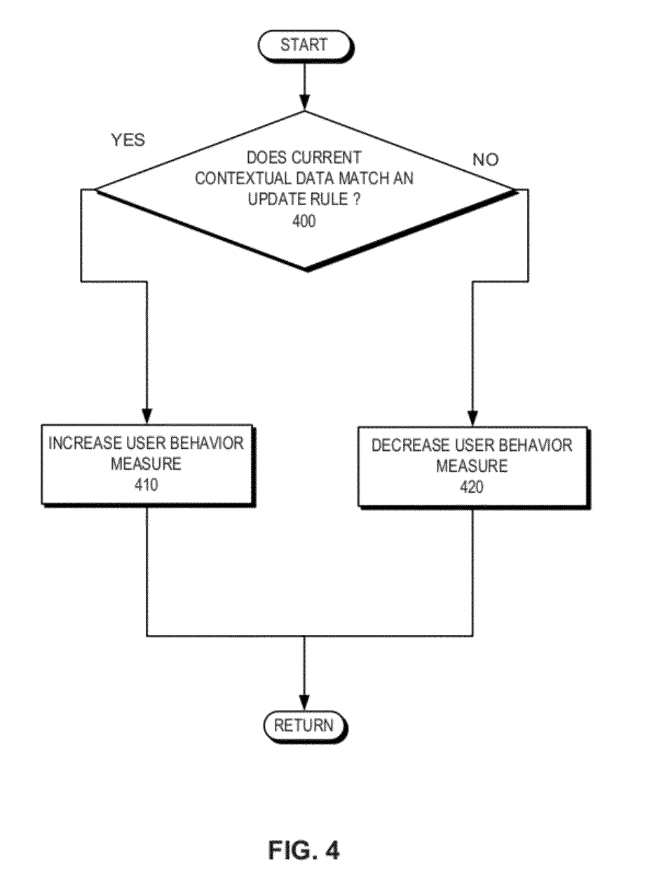

FIG. 4 presents a flow chart illustrating the process of adjusting a user behavior measure based on the current contextual data in accordance with an embodiment of the present invention. The system starts by determining whether the current contextual data matches a behavior measure update rule (operation 400). When an update rule is triggered, the user behavior measure is increased or adjusted upwards (operation 410). Otherwise, the user behavior measure is decreased or adjusted downwards (operation 420). For example, the system determines a user location one mile away from a regular geographic area, which matches an update rule stating that a user location within two miles from the regular location is regarded normal. The user behavior measure will be increased as being consistent with the regular user behavior model, whereas if the user device is spotted a thousand miles away from the regular location, the user behavior measure will be adjusted downwards because of anomalous user behavior.

### Apparatus for Implicit Authentication

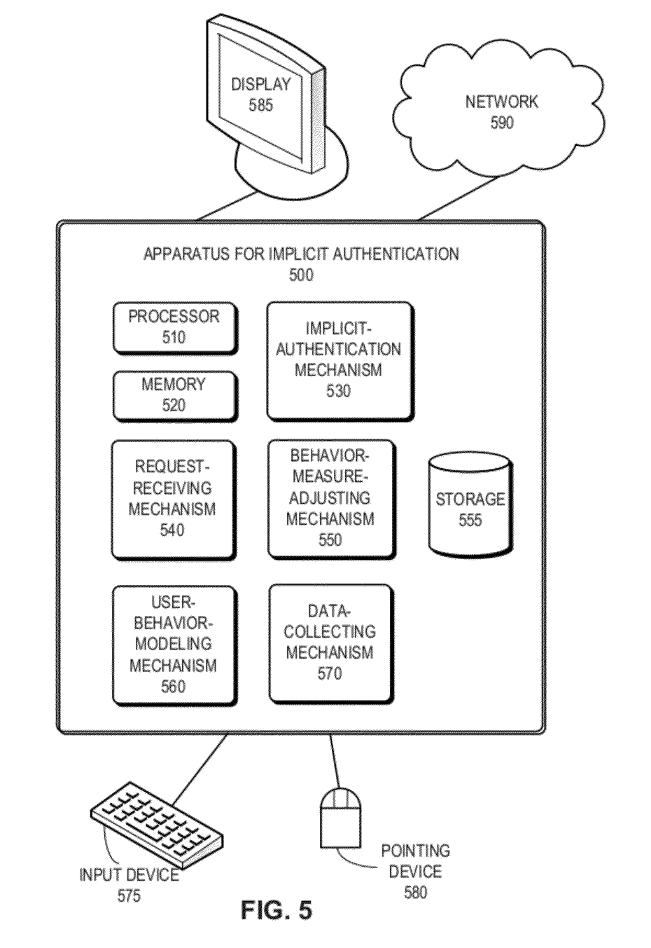

FIG. 5 shows a block diagram illustrating an apparatus 500 for implicitly authenticating a user to access a controlled resource in accordance with an embodiment of the present invention. The apparatus 500 includes a processor 510, a memory 520, a request-receiving mechanism 540, a user-behavior-modeling mechanism 560, an implicit-authenticating mechanism 530, a behavior-measure-adjusting mechanism 550, a data-collecting mechanism 570, and storage 555. The apparatus 500 can be coupled with a display 585, a network 590, an input device 575 and a pointing device 580.

The implicit-authenticating mechanism 530 calculates the implicit authentication information based on the user behavior measure. The implicit-authenticating mechanism 530 can be any computing component with a processing logic.

The request-receiving mechanism 540 receives a user access request from a user. The request-receiving mechanism 540 can be a network port, a wireless receiver, a radio receiver, a media receiver, or any other receiving component without limitations.

The behavior-measure-adjusting mechanism 550 adjusts a user behavior measure of the user who initiates the user access request. The behavior-measure-adjusting mechanism 550 can be any computing component with a processing logic and a communication mechanism. The communication mechanism includes a mechanism for communicating through a cable network, a wireless network, a radio network, a digital media network, etc., without any limitations.

The user-behavior-modeling mechanism 560 creates a user behavior model based on the contextual data about a user collected by the data-collecting mechanism 570. The user-behavior-modeling mechanism 560 can be any type of computing component with a computational mechanism.

The data-collecting mechanism 570 collects current contextual data about the user. The data-collecting mechanism 570 can be any device with a communication mechanism and can work with the storage 555. In some embodiments, the data-collecting mechanism 570 sends the collected recent contextual data to the behavior-measure-adjusting mechanism 550. In other embodiments, the data-collecting mechanism 570 sends the contextual data to the user-behavior-modeling mechanism 560.

The storage 555 can include, but is not limited to, a random access memory (RAM), flash memory, a magnetic storage system, an optical storage system, and magneto-optical storage devices.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed.

Accordingly, many modifications and variations will be apparent to practitioners skilled in the art. Additionally, the above disclosure is not intended to limit the present invention. The scope of the present disclosure is defined by the appended claims.

What is claimed is:

1. A computer-implemented method for implicitly authenticating a user to access a controlled resource, the method comprising:
receiving a request to access the controlled resource from a user;
determining whether the user request is inconsistent with regular user behavior by calculating a user behavior measure derived from historical contextual data of past user events;
responsive to the determined inconsistency of the user request, collecting current contextual data of the user from one or more user devices without prompting the user to perform an explicit action for authentication;
updating the user behavior measure based on the collected current contextual data; and
providing the updated user behavior measure to an access controller of the controlled resource to make an authentication decision based at least on the updated user behavior measure.

2. The method of claim 1, wherein calculating the user behavior measure comprises:
determining a quality measure which is a scale indicating the likelihood of an event associated with the user happening in a given context;
determining a weight indicating the relative importance of a given event; and
adjusting the user behavior measure based on the quality measure and the weight.

3. The method of claim 1, wherein the current contextual data of the user comprise one or more of: location data, time data, calendar information, social network information, communication information, and online data.

4. The method of claim 1, wherein updating the user behavior measure further comprises applying a set of heuristic rules to adjust the user behavior measure based on the collected current contextual data.

5. The method of claim 1, further comprising:
deriving updating rules for the user behavior measure from the collected current contextual data.

6. The method of claim 5, wherein deriving the updating rules comprises generating a set of rules using machine-learning technique from the collected current contextual data.

7. The method of claim 1, further comprising:
determining whether the updated user behavior measure meets a predetermined threshold value; and
responsive to the updated user behavior measure meeting the threshold value, authenticating the user to access the controlled resource.

8. The method of claim 7, further comprising:
responsive to the updated user behavior measure not meeting the threshold value, prompting the user to perform a further authentication.

9. A non-transitory computer-readable storage medium storing instructions that when executed by a computer cause the computer to perform a method for implicitly authenticating a user to access a controlled resource, the method comprising:
receiving a request to access the controlled resource from a user;
determining whether the user request is inconsistent with regular user behavior by calculating a user behavior measure derived from historical contextual data of past user events;
responsive to the determined inconsistency of the user request, collecting current contextual data of the user from one or more user devices without prompting the user to perform an explicit action for authentication;
updating the user behavior measure based on the collected current contextual data; and
providing the updated user behavior measure to an access controller of the controlled resource to make an authentication decision based at least on the updated user behavior measure.

10. The computer-readable storage medium of claim 9, wherein calculating the user behavior measure comprises:
determining a quality measure which is a scale indicating the likelihood of an event associated with the user happening in a given context;
determining a weight indicating the relative importance of a given event;
and adjusting the user behavior measure based on the quality measure and the weight.

11. The computer-readable storage medium of claim 9, wherein the current contextual data of the user comprise one or more of: location data, time data, calendar information, social network information, communication information, and online data.

12. The computer-readable storage medium of claim 9, wherein updating the user behavior measure further comprises applying a set of heuristic rules to adjust the user behavior measure based on the collected current contextual data.

13. The computer-readable storage medium of claim 9, further comprising:
deriving updating rules for the user behavior measure from the collected current contextual data.

14. The computer-readable storage medium of claim 13, wherein deriving the updating rules comprises generating a set of rules using machine-learning technique from the collected current contextual data.

15. The computer-readable storage medium of claim 9, further comprising:
determining whether the updated user behavior measure meets a predetermined threshold value; and
responsive to the updated user behavior measure meeting the threshold value, authenticating the user to access the controlled resource.

16. The computer-readable storage medium of claim 15, further comprising:
responsive to the updated user behavior measure not meeting the threshold value, prompting the user to perform a further authentication.

17. A system for implicitly authenticating a user to access a controlled resource, the system comprising:
a user access request receiver configured to receive a request from a user to access the controlled resource;
a determination mechanism configured to determine whether the user request is inconsistent with regular user behavior by calculating a user behavior measure derived from historical contextual data of past user events;
a contextual data collecting mechanism configured to, responsive to the determined inconsistency of the user request, collect current contextual data of the user from one or more user devices without prompting the user to perform an explicit action for authentication;
an updating mechanism configure to update the user behavior measure based on the collected current contextual data; and
an authentication information provision mechanism configured to provide the updated user behavior measure to an access controller of the controlled resource to make an authentication decision based at least on the updated user behavior measure.

18. The system of claim 17, wherein calculating the user behavior measure comprises:
determining a quality measure which is a scale indicating the likelihood of an event associated with the user happening in a given context;
determining a weight indicating the relative importance of a given event; and
adjusting the user behavior measure based on the quality measure and the weight.

19. The system of claim 17, wherein the current contextual data of the user comprise one or more of: location data, time data, calendar information, social network information, communication information, and online data.

20. The system of claim 17, wherein the updating mechanism is further configured to apply a set of heuristic rules to adjust the user behavior measure based on the collected current contextual data.

21. The system of claim 17, further comprising a model-deriving mechanism configured to derive updating rules for the user behavior measure from the collected current contextual data.

22. The system of claim 21, wherein the model-deriving mechanism is further configured to generate a set of rules using machine-learning technique from the collected current contextual data.

23. The system of claim 17, further comprising:
a determination mechanism configured to determine whether the updated user behavior measure meets a predetermined threshold value; and
an authentication mechanism configured to, responsive to the updated user behavior measure meeting the threshold value, authenticate the user to access the controlled resource.

24. The system of claim 23, wherein the authentication mechanism is further configured to:
responsive to the updated user behavior measure not meeting the threshold value, prompt the user to perform a further authentication.
